(19) United States
(12) Patent Application Publication
(10) Pub. No.: US 2020/0225833 A1
(43) Pub. Date: Jul. 16, 2020

(54) MONITORING AND CONTROLLING A SMOKE CONTROL SYSTEM

(71) Applicant: Honeywell International Inc., Morris Plains, NJ (US)

(72) Inventors: Kanaka Nagendra Prasad Naraharisetti, Bangalore (IN); P Ranjith Kumar, Bangalore (IN); Rajesh Babu Nalukurthy, Bangalore (IN); Rich Lau, Morris Plains, NJ (US)

(21) Appl. No.: 16/245,091

(22) Filed: Jan. 10, 2019

(51) Int. Cl. G06F 3/0484; A62C 2/06; F24F 11/33

(52) U.S. Cl. CPC G06F 3/04842; F24F 11/33; A62C 3/14; G06F 3/04847

(57) ABSTRACT

Devices, methods, and systems for monitoring and controlling a smoke control system are described herein. One device includes a user interface configured to display a plurality of smoke control elements, wherein each respective one of the displayed smoke control elements represents a different component of a smoke control system of a facility, and receive, via one of the displayed smoke control elements, a selection of an action to be performed by the component of the smoke control system represented by that smoke control element, a memory, and a processor configured to execute executable instructions stored in the memory to cause the action to be performed by the component of the smoke control system represented by the smoke control element that received the selection of the action.

### TECHNICAL FIELD

The present disclosure relates generally to devices, methods, and systems for monitoring and controlling a smoke control system.

### BACKGROUND

Large facilities (e.g., buildings), such as commercial facilities, office buildings, hospitals, and the like, may have smoke control systems that can be used during an emergency situation (e.g., a fire) to manage the flow of smoke through the facility. For example, a smoke control system may include a number of components, such as fans and/or dampers, located throughout the facility (e.g., on different floors of the facility) that can be used to perform smoke control operations, such as pressurizing, purging, exhausting, etc.

A smoke control system may also include a physical smoke control panel (e.g., box) installed in the facility that can be used by a user (e.g., operator) to directly control the operation of the components of the smoke control system. However, such a physical smoke control panel may require a large, complex amount of physical hardware and/or may occupy a large amount space in the facility, especially if the facility is a large facility that has many floors. Further, it can be difficult, costly, and/or time consuming to customize the physical smoke control panel to the particular needs of the facility and/or to make changes to the panel after it has been installed.

### BRIEF DESCRIPTION OF THE DRAWINGS

FIG. 1 illustrates an example of a computing device for monitoring and controlling a smoke control system in accordance with an embodiment of the present disclosure.

FIGS. 2A-2B illustrate examples of smoke control elements in accordance with an embodiment of the present disclosure.

FIG. 3 illustrates an example of a display of smoke control elements representing different components of a smoke control system of a facility in accordance with an embodiment of the present disclosure.

FIG. 4 illustrates an example of a display of smoke control elements representing different components of a smoke control system of a facility in accordance with an embodiment of the present disclosure.

### DETAILED DESCRIPTION

Devices, methods, and systems for monitoring and controlling a smoke control system are described herein. For example, an embodiment includes a user interface configured to display a plurality of smoke control elements, wherein each respective one of the displayed smoke control elements represents a different component of a smoke control system of a facility, and receive, via one of the displayed smoke control elements, a selection of an action to be performed by the component of the smoke control system represented by that smoke control element, a memory, and a processor configured to execute executable instructions stored in the memory to cause the action to be performed by the component of the smoke control system represented by the smoke control element that received the selection of the action.

In contrast to previous smoke control systems in which a physical smoke control panel is installed in a facility to control the operation of the components (e.g., fans and/or dampers) of the smoke control system, smoke control systems in accordance with the present disclosure allow for the components of the smoke control system to be monitored and/or controlled using digital graphics (e.g., widgets) displayed to a user (e.g., operator) on a digital display (e.g., a computer screen). Accordingly, smoke control systems in accordance with the present disclosure may have significantly less (e.g., no additional) physical hardware, and/or occupy a significantly less amount of space in the facility, than previous smoke control systems that utilize a physical control panel, while still providing the same functionality that is provided by a physical control panel.

As such, smoke control systems in accordance with the present disclosure can be easier, less costly, and/or less time consuming to install, customize, and/or change (e.g., update) than previous smoke control systems that utilize a physical control panel. Further, smoke control systems in accordance with the present disclosure can make it easier (e.g., more intuitive) for the user to monitor and/or control the components of the smoke control system than previous approaches that utilize a physical control panel.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

The figures herein follow a numbering convention in which the first digit or digits correspond to the drawing figure number and the remaining digits identify an element or component in the drawing. Similar elements or components between different figures may be identified by the use of similar digits.

As used herein, “a”, “an”, or “a number of” something can refer to one or more such things, while “a plurality of” something can refer to more than one such things. For example, “a number of components” can refer to one or more components, while “a plurality of components” can refer to more than one component.

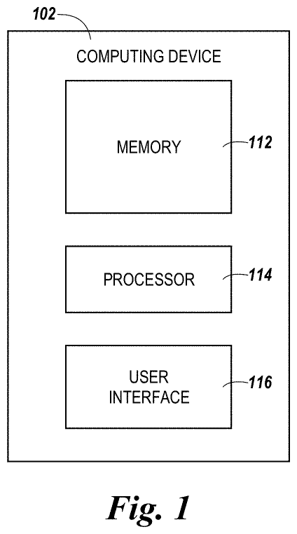

FIG. 1 illustrates an example of a computing device 102 for monitoring and controlling a smoke control system in accordance with an embodiment of the present disclosure. The smoke control system can be the smoke control system of a facility (e.g., building), such as, for instance, a large facility having a large number of floors, such as a commercial facility, office building, hospital, and the like. However, embodiments of the present disclosure are not limited to a particular type of facility.

Computing device 102 can be, refer to, and/or include a laptop computer, desktop computer, or mobile device, such as, for instance, a smart phone or tablet, among other types of computing devices. However, embodiments of the present disclosure are not limited to a particular type of computing device. Computing device 102 may be located at the facility, such as, for instance, in a control room or operating room of the facility, or may be located remotely from the facility.

The smoke control system can be used during an emergency situation (e.g., a fire) to manage the flow of smoke through the facility. For example, the smoke control system may include a number of components, such as fans and/or dampers, located throughout the facility (e.g., on different floors of the facility) that can be used to perform smoke control operations, such as pressurizing, purging, exhausting, etc., in the facility. As used herein, monitoring and controlling the smoke control system can include and/or refer to monitoring and controlling the components (e.g., the operation of the components) of the smoke control system, as will be further described herein.

Computing device 102 can monitor and/or control the components of the smoke control system via a wired or wireless network. The network can be a network relationship through which computing device 102 can communicate with the components of the smoke control system. Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive information from, and transmit information to, computing device 102 and the components of the smoke control system via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

As shown in FIG. 1, computing device 102 can include a processor 114 and a memory 112. Memory 112 can be any type of storage medium that can be accessed by processor 114 to perform various examples of the present disclosure. For example, memory 112 can be a non-transitory computer readable medium having computer readable instructions (e.g., computer program instructions) stored thereon that are executable by processor 114 to control a smoke control system in accordance with the present disclosure. That is, processor 114 can execute the executable instructions stored in memory 132 to control a smoke control system in accordance with the present disclosure.

Memory 112 can be volatile or nonvolatile memory. Memory 112 can also be removable (e.g., portable) memory, or non-removable (e.g., internal) memory. For example, memory 112 can be random access memory (RAM) (e.g., dynamic random access memory (DRAM), resistive random access memory (RRAM), and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 112 is illustrated as being located in computing device 102, embodiments of the present disclosure are not so limited. For example, memory 112 can also be located internal to another computing resource (e.g., enabling computer readable instructions to be downloaded over the Internet or another wired or wireless connection).

As shown in FIG. 1, computing device 102 can include a user interface 116. A user (e.g., operator) of computing device 102, such as, for instance, an operator of the smoke control system, can interact with computing device 102 via user interface 116. For example, user interface 116 can provide (e.g., display) information to and/or receive information from (e.g., input by) the user of computing device 102.

In some embodiments, user interface 116 can be a graphical user interface (GUI) that can include a display (e.g., a screen) that can provide information to, and/or receive information from, the user of computing device 102. The display can be, for instance, a touch-screen (e.g., the GUI can include touch-screen capabilities). As an additional example, user interface 116 can include a keyboard and/or mouse the user can use to input information into computing device 102, and/or a speaker that can play audio to, and/or receive audio (e.g., voice input) from, the user. Embodiments of the present disclosure, however, are not limited to a particular type(s) of user interface.

As an example, user interface 116 can display a plurality of smoke control elements (e.g., widgets) with which the user of computing device 102 can interact (e.g., through direct manipulation). Each respective one of the displayed smoke control elements can represent a different component (e.g., a different damper or fan) of the smoke control system of the facility, and can include a plurality of actions that can be performed by (e.g., selected by the user to be performed by) the component represented by that smoke control element. For example, the actions included in a smoke control element that represents a damper of the smoke control system can include opening the damper, closing the damper, and operating the damper in auto mode. As an additional example, the actions included in a smoke control element that represents a fan of the smoke control system can include turning (e.g., switching) on the fan, turning off the fan, and operating the fan in auto mode.

Further, each respective one of the displayed smoke control elements can include an indication of the current operational state of the component represented by that smoke control element. For example, the indication of the current operational state included in a smoke control element that represents a damper of the smoke control system can be an indication of whether the damper is open or closed (e.g., the current operational state of the damper may be open or closed). Further, the indication of the current operational state included in a smoke control element that represents a fan of the smoke control system can be an indication of whether the fan is on or off (e.g., the operational state of the fan may be on or off).

Further, each respective one of the displayed smoke control elements can include a visual representation of the type of component represented by that smoke control element. For example, if the component represented by a smoke control element is a damper, that smoke control element can include a visual representation of a damper. Further, if the component represented by a smoke control element is a fan, that smoke control element can include a visual representation of a fan.

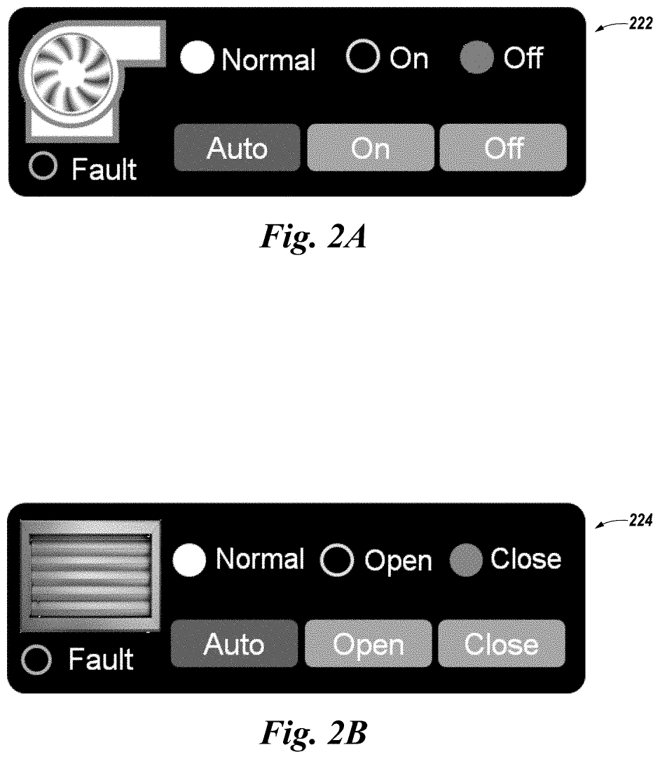

Further, each respective one of the displayed smoke control elements can include an indication of whether the component represented by that smoke control element is operating normally, or has a fault associated therewith (e.g., is faulty). Examples of smoke control elements that can be displayed on user interface 116 will be further described herein (e.g., in connection with FIGS. 2A and 2B).

In some embodiments, all the components of the smoke control system of the facility can be represented by a different respective smoke control element in the display, and user interface 116 can continuously display the smoke control elements in a separate (e.g., the same) window in user interface 116, which can be designated as the smoke control screen. Accordingly, all the components (e.g., smoke control elements for all the components) of the smoke control system of the facility can be continuously visible to the user of computing device 102.

Further, user interface 116 can display an indication of whether all the components of the smoke control system of the facility are operating in auto mode, or any of the components are being operated manually (e.g., being controlled by the user of computing device 102). Further, user interface 116 can display an indication of whether any of the components of the smoke control system of the facility have a fault associated therewith (e.g., whether any of the components are faulty).

As an example, the display on user interface 116 can include a schematic floor plan of the facility, and the smoke control elements representing the different components of the smoke control system of the facility can be displayed within the display of the schematic floor plan, with the position of each respective smoke control element within the display of the schematic floor plan corresponding to the location (e.g., the floor) in the facility of the component represented by that smoke control element. If multiple components of the smoke control system are located at a particular location (e.g., on the same floor) in the facility, the quantity (e.g., number) of components that are at that particular location in the facility can be displayed at the position within the schematic floor plan display that corresponds to that particular location, and the smoke control elements representing the components that are at that particular location in the facility can be displayed upon that corresponding position within the schematic floor plan display being selected by the user of computing device 102.

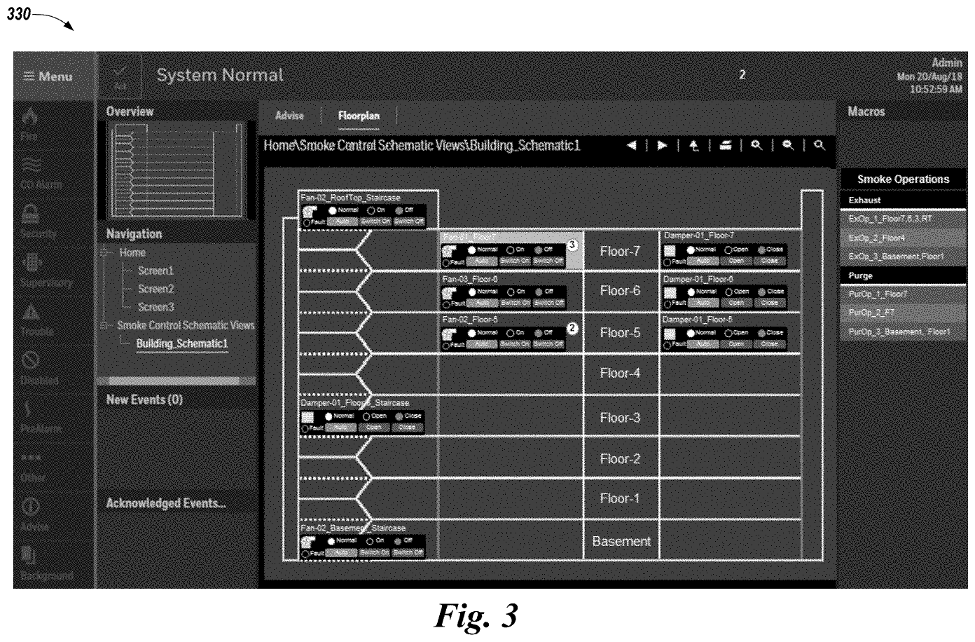

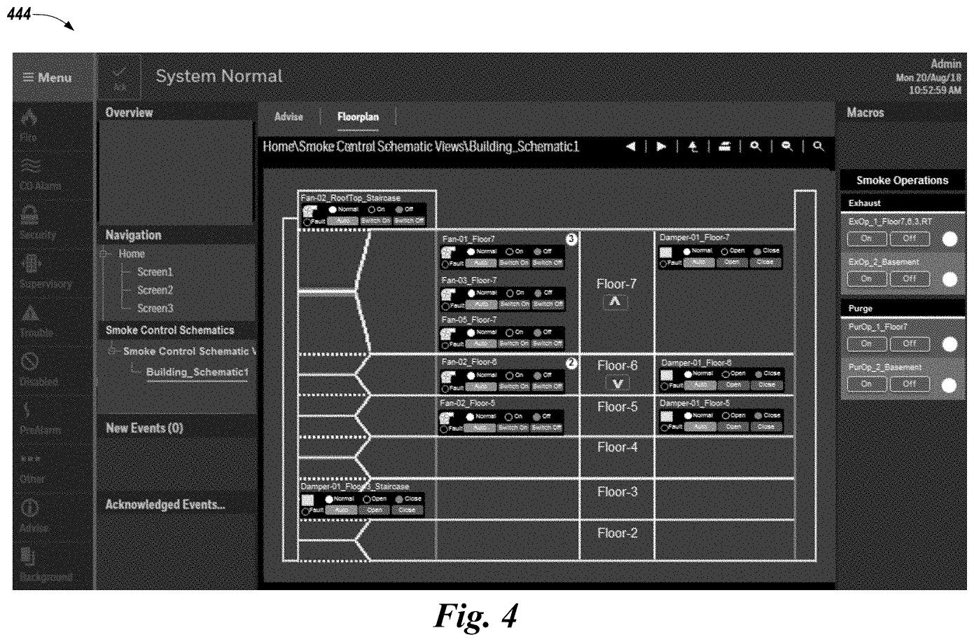

Further, upon a component of the smoke control system of the facility having a fault associated therewith, the position of the smoke control element that represents that component within the display of the schematic floor plan can be highlighted. Examples of displays that include a schematic floor plan of a facility, and smoke control elements representing the different components of the smoke control system of the facility within the schematic floor plan, will be further described herein (e.g., in connection with FIGS. 3 and 4).

User interface 116 can receive, via one of the displayed smoke control elements, a selection of an action to be performed by the component of the smoke control system of the facility represented by that smoke control element. For example, the user of computing device 102 can select one of the plurality of actions included in that smoke control element to be performed by the component represented by that smoke control element. The user can select the action to be performed by, for example, using the mouse of the user interface to select the action in that smoke control element in the display, or by touching the action in that smoke control element in the display.

As an example, if the user would like to open or close a particular damper of the smoke control system of the facility, the user can select that action in the displayed smoke control element that represents that damper. As an additional example, if the user would like to turn a particular fan of the smoke control system on or off, the user can select that action in the displayed smoke control element that represents that fan. As an additional example, if the user would like a particular damper or fan of the smoke control system to operate in auto mode, the user can select that action in the displayed smoke control element that represents that damper or fan.

Upon user interface 116 receiving the selection of the action, computing device 102 can cause the action to be performed by the component of the smoke control system represented by the smoke control element that received the selection. For example, computing device 102 can send (e.g., via the network previously described herein) an instruction (e.g., command) to that component to perform the selected action, and the component can perform the selected action upon receipt of the instruction.

In some embodiments, the action performed by the component of the smoke control system can be one of a plurality (e.g., sequence) of actions being performed by the different components of the smoke control system as part of a single, customizable operation of the smoke control system. For instance, several individual actions of various fans and/or dampers of the smoke control system can be combined (e.g., using computing device 102) into a purge, exhaust, or pressurization operation to be performed by the smoke control operation. In such an example, the user of computing device 102 can select, via user interface 116, the operation to be performed by the smoke control system, and computing device 102 can cause the actions to be performed by the respective components in the sequence of the operation.

Upon the component of the smoke control system performing the selected action, user interface 116 can display a graphical animation of the smoke control element that received the selection of the action (e.g., to provide a visual confirmation to the user that the selected action is being performed). For instance, user interface 116 can perform a graphical animation of the visual representation of the component represented by that smoke control element. The graphical representation can be based on the type of the component that is represented by that smoke control element, and can correspond to the action performed by the component.

As an example, if the component represented by the smoke control element that received the selection of the action is a damper, and the selected action is an opening or closing of the damper, the graphical animation can show an opening or closing, respectively, of the visual representation of that damper included in the smoke control element. As an additional example, if the component represented by the smoke control element that received the selection of the action is a fan, and the selected action is turning the fan on or off, the graphical animation can show the visual representation of that fan included in the smoke control element turning on or off, respectively.

Further, upon the component of the smoke control system performing the selected action, the indication of the current operational state included in the smoke control element that represents that component may change (e.g., update) based on the selected action (e.g., to correspond to the changed operational state of the component). As an example, if the component represented by the smoke control element that received the selection of the action is a damper, and the selected action is an opening or closing of the damper, the indication of the current operational state included in the smoke control element that represents that damper can change from closed to open, or from open to closed, respectively. As an additional example, if the component represented by the smoke control element that received the selection of the action is a fan, and the selected action is turning the fan on or off, the indication of the current operational state included in the smoke control element that represents that fan can change from off to on, or from on to off, respectively. This can also provide a visual confirmation to the user that the selected action has been performed.

FIGS. 2A-2B illustrate examples of smoke control elements (e.g., widgets) in accordance with an embodiment of the present disclosure. For instance, FIG. 2A illustrates an example of a smoke control element 222 that represents a fan of a smoke control system of a facility, and FIG. 2B illustrates an example of a smoke control element 224 that represents a damper of a smoke control system of a facility. Smoke control elements 222 and 224 can be displayed on a user interface, such as, for instance, user interface 116 of computing device 102 previously described in connection with FIG. 1, and the smoke control system of the facility can be analogous to the smoke control system of the facility previously described in connection with FIG. 1.

As shown in FIG. 2A and 2B, smoke control elements 222 and 224 each include three different actions (e.g., selectable icons corresponding to three different actions) that can be performed by the fan and damper, respectively, that they represent. For instance, smoke control element 222 includes the actions of turning (e.g., switching) on the fan (represented by the “On” icon at the bottom of the control element), turning off the fan (represented by the “Off” icon at the bottom of the control element), and operating the fan in auto mode (represented by the “Auto” icon at the bottom of the control element). Smoke control element 224 includes the actions of opening the damper (represented by the “Open” icon at the bottom of the control element), closing the damper (represented by the “Close” icon at the bottom of the control element), and operating the damper in auto mode (represented by the “Auto” icon at the bottom of the control element).

A user can select one of the actions (e.g., the icon representing that actions) to be performed by the fan or damper, and the fan or damper can perform the selected action responsive to the selection, as previously described herein (e.g., in connection with FIG. 1). In the examples illustrated in FIGS. 2A and 2B, the fan and damper, respectively, have been selected to operate in auto mode (represented by the illumination of the “Auto” icon in each respective control element).

Further, as shown in FIGS. 2A and 2B, smoke control elements 222 and 224 can include an indication of the current operational state of the fan and damper, respectively, that they represent. For instance, smoke control element 222 includes an indication that the current operational state of the fan is off (represented by the “Off” indicator at the top of the control element being illuminated, while the “On” indicator at the top of the control element is not illuminated), and smoke control element 224 includes an indication that the current operational state of the damper is closed (represented by the “Close” indicator at the top of the control element being illuminated, while the “Open” indicator at the top of the control element is not illuminated).

Upon the fan or damper performing a selected action, the indication of the current operational state of the fan or damper may change (e.g., update) based on the selected action (e.g., to correspond to the changed operational state of the component). For example, if the user were to select the action of turning on the fan, the “On” indicator of smoke control element 222 would be illuminated, and the “Off” indicator of smoke control element 222 would no longer be illuminated. If the user were to select the action of opening the damper, the “Open” indicator of smoke control element 224 would be illuminated, and the “Close” indicator of smoke control element 224 would no longer be illuminated. Further, the “Auto” icon of the respective control element would no longer be illuminated, to reflect that the user has made a manual selection of the action.

Further, as shown in FIGS. 2A and 2B, smoke control elements 222 and 224 can include a visual representation of the type of component of the smoke control system they represent. For example, smoke control element 222 includes a visual representation of a fan, and smoke control element 224 includes a visual representation of a damper.

Upon the fan or damper performing a selected action, a graphical animation of the visual representation of fan or damper included in smoke control element 222 or 224, respectively, may be displayed (e.g., performed). For example, if the user were to select the action of turning on the fan, smoke control element 222 may display a graphical animation of the visual representation of the fan turning on (e.g., turn on the visual representation of the fan included in the control element). If the user were to select the action of opening the damper, smoke control element 224 may display a graphical animation of the visual representation of the damper opening (e.g., open the visual representation of the damper included in the control element).

Further, as shown in FIGS. 2A and 2B, smoke control elements 222 and 224 can include an indication of whether the fan and damper, respectively, that they represent is operating normally, or has a fault associated therewith. For instance, smoke control elements 222 and 224 includes an indication that the the fan and damper, respectively are operating normally (represented by the “Normal” indicator being illuminated, while the “Fault” indicator is not illuminated). If the fan or damper were to have a fault associated therewith (e.g., be faulty), the “Fault” indicator in smoke control element 222 or 224, respectively, would be illuminated.

FIG. 3 illustrates an example of a display 330 of smoke control elements representing different components of a smoke control system of a facility in accordance with an embodiment of the present disclosure. Display 330 can be displayed on a user interface, such as, for instance, user interface 116 of computing device 102 previously described in connection with FIG. 1, and the smoke control system of the facility can be analogous to the smoke control system of the facility previously described in connection with FIG. 1.

As shown in FIG. 3, display 330 includes a plurality of smoke control elements (e.g., widgets) that each represent a different component of the smoke control system of a facility. For example, display 330 includes smoke control elements representing a fan in the basement staircase of the facility, a damper in the floor 3 staircase of the facility, a fan in the rooftop staircase of the facility, and fans and dampers on each of floors 5, 6, and 7 of the facility, as illustrated in FIG. 3. Each smoke control element includes a plurality of actions that can be performed by the component represented by that smoke control element, an indication of the current operational state of the component represented by that smoke control element, a visual representation of the type of component represented by that smoke control element, and an indication of whether the component represented by that smoke control element is operating normally, or has a fault associated therewith, in a manner analogous to that previously described herein.

Further, as shown in FIG. 3, display 330 can include a schematic floor plan of the facility. The schematic floor plan of the facility includes the different floors of the facility (e.g., the basement and floors 1 through 7), and the staircase of the facility, as illustrated in FIG. 3.

As shown in FIG. 3, the smoke control elements representing the different components of the smoke control system of the facility are displayed within the schematic floor plan of display 330, with the position of each respective smoke control element within the schematic floor plan corresponding to the location in the facility of the component represented by that smoke control element. For instance, as illustrated in FIG. 3, the smoke control elements representing the fan in the basement staircase of the facility, the damper in the floor 3 staircase of the facility, and the fan in the rooftop staircase of the facility are positioned in the basement staircase, floor 3 staircase, and rooftop staircase, respectively, in the schematic floor plan. Further, the smoke control elements representing the fans and damper of floor 5 of the facility are positioned in floor 5 of the schematic floor plan, the smoke control elements representing the fan and damper of floor 6 of the facility are positioned in floor 6 of the schematic floor plan, and the smoke control elements representing the fans and damper of floor 7 of the facility are positioned in floor 7 of the schematic floor plan, as illustrated in FIG. 3.

As shown in FIG. 3, if multiple components of the smoke control system are located at a particular location in the facility, the quantity (e.g., number) of components that are at that particular location in the facility, along with the smoke control element representing one of the components at that particular location, can be displayed at the position within the schematic floor plan in display 330 that corresponds to that particular location. For instance, in the example illustrated in FIG. 3, two fans are located on floor 5 of the facility, and three fans are located on floor 7 of the facility. As such, a 2 is displayed in floor 5 of the schematic floor plan along with the smoke control element representing one of those fans (e.g., to indicate that floor 5 includes two fans), and a 3 is displayed in floor 7 of the schematic floor plan along with the smoke control element representing one of those fans (e.g., to indicate that floor 7 includes three fans), as illustrated in FIG. 3. The smoke control elements representing all the components at that particular location in the facility can all be displayed upon that corresponding position within the schematic floor plan being selected, as will be further described herein (e.g., in connection with FIG. 4).

As shown in FIG. 3, if a component of the smoke control system of the facility has a fault associated therewith, the position of the smoke control element that represents that component within the schematic floor plan can be highlighted. For instance, in the example illustrated in FIG. 3, one of the fans on floor 7 has a fault associated therewith. As such, floor 7 is highlighted in the schematic floor plan (e.g., to indicate that one of the fans on floor 7 is faulty).

Display 330 can receive, via one of the displayed smoke control elements, a selection of an action to be performed by the component of the smoke control system of the facility represented by that smoke control element, in a manner analogous to that previously described herein. Upon display 330 receiving such a selection, the action can be performed by the component of the smoke control system represented by the smoke control element, as previously described herein. Upon the action being performed by that component of the smoke control system, a graphical animation of the smoke control element that received the selection of the action can be performed in display 330, and the indication of the current operational state of the component in the smoke control element may change, as previously described herein.

FIG. 4 illustrates an example of a display 444 of smoke control elements representing different components of a smoke control system of a facility in accordance with an embodiment of the present disclosure. Display 444 can be analogous to display 330 previously described in connection with FIG. 3, except that a selection of a position within the schematic floor plan of the display has been made, such that the smoke control elements representing all components of the smoke control system at that corresponding location in the facility are displayed.

For instance, in the example illustrated in FIG. 4, three fans are located on floor 7 of the facility (e.g., as indicated by the 3 displayed in floor 7 of the schematic floor plan of display 444), and a selection of floor 7 (e.g., of the icon in floor 7) within the schematic floor plan has been made, such that the smoke control elements representing all three fans on floor 7 of the facility are shown in display 444, as illustrated in FIG. 4. For instance, the view of floor 7 in the schematic floor plan in display 444 has been expanded to include the smoke control elements representing all three fans on floor 7, as illustrated in FIG. 4.

A subsequent selection of the position within the schematic floor plan can result in the smoke control element representing only one of the components at that corresponding location to be displayed, with the smoke control elements representing the other components at that location being hidden. For instance, in the example illustrated in FIG. 4, a subsequent selection of floor 7 within the schematic floor plan can cause the expanded view of floor 7 to collapse, such that the smoke control element representing only one of the fans on floor 7 is displayed.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computing device for monitoring and controlling a smoke control system, comprising:
a user interface configured to:
display a plurality of smoke control elements, wherein each respective one of the displayed smoke control elements represents a different component of a smoke control system of a facility; and
receive, via one of the displayed smoke control elements, a selection of an action to be performed by the component of the smoke control system represented by that smoke control element;
a memory; and
a processor configured to execute executable instructions stored in the memory to cause the action to be performed by the component of the smoke control system represented by the smoke control element that received the selection of the action.

2. The computing device of claim 1, wherein the component of the smoke control system represented by the smoke control element that received the selection of the action is a damper of the smoke control system.

3. The computing device of claim 1, wherein the component of the smoke control system represented by the smoke control element that received the selection of the action is a fan of the smoke control system.

4. The computing device of claim 1, wherein the user interface is configured to display a graphical animation of the smoke control element that received the selection of the action upon the performance of the action.

5. The computing device of claim 1, wherein the user interface is configured to display an indication of whether all components of the smoke control system of the facility are operating in auto mode or any of the components of the smoke control system of the facility are being operated manually.

6. The computing device of claim 1, wherein the user interface is configured to display an indication of whether any components of the smoke control system have a fault associated therewith.

7. The computing device of claim 1, wherein all components of the smoke control system of the facility are represented by a smoke control element in the display.

8. The computing device of claim 1, wherein the user interface is configured to continuously display the plurality of smoke control elements in a separate window in the user interface.

9. A method for monitoring and controlling a smoke control system, comprising:
displaying, on a user interface of a computing device, a plurality of smoke control elements, wherein each respective one of the displayed smoke control elements represents a different damper or fan of a smoke control system of a facility;
receiving, via one of the displayed smoke control elements, a selection of an action to be performed by the damper or fan represented by that smoke control element; and
performing, by the damper or fan represented by the smoke control element that received the selection of the action, the action.

10. The method of claim 9, wherein:
each respective one of the displayed smoke control elements includes a plurality of actions to be performed by the damper or fan represented by that smoke control element; and
receiving the selection of the action to be performed by the damper or fan represented by that smoke control element comprises receiving a selection of one of the plurality of actions included in that smoke control element.

11. The method of claim 10, wherein:
the plurality of actions included in the smoke control elements that represent a damper of the smoke control system include:
opening the damper;
closing the damper; and
operating the damper in auto mode; and
the plurality of actions included in the smoke control elements that represent a fan of the smoke control system include:
turning on the fan;
turning off the fan; and
operating the fan in auto mode.

12. The method of claim 9, wherein each respective one of the displayed smoke control elements includes an indication of a current operational state of the damper or fan represented by that smoke control element.

13. The method of claim 12, wherein:
the indication of the current operational state included in the smoke control elements that represent a damper of the smoke control system includes an indication of whether the damper is open or closed; and
the indication of the current operational state included in the smoke control elements that represent a fan of the smoke control system includes an indication of whether the fan is on or off.

14. The method of claim 9, wherein each respective one of the displayed smoke control elements includes an indication of whether the damper or fan represented by that smoke control element has a fault associated therewith.

15. A non-transitory computer readable medium having computer readable instructions stored thereon that are executable by a processor to:
display, on a graphical user interface, a plurality of smoke control elements, wherein each respective one of the displayed smoke control elements represents a different component of a smoke control system of a facility;
receive, via one of the displayed smoke control elements, a selection of an action to be performed by the component of the smoke control system represented by that smoke control element;
cause the action to be performed by the component of the smoke control system represented by the smoke control element that received the selection of the action; and
display, on the graphical user interface, a graphical animation of the smoke control element that received the selection of the action upon the performance of the action.

16. The computer readable medium of claim 15, wherein the graphical animation is based on a type of the component of the smoke control system represented by the smoke control element that received the selection of the action.

17. The computer readable medium of claim 15, wherein the plurality of smoke control elements comprise a plurality of widgets.

18. The computer readable medium of claim 15, wherein the instructions are executable by the processor to:
display, on the graphical user interface, a schematic floor plan of the facility; and
display, on the graphical user interface, the plurality of smoke control elements within the display of the schematic floor plan of the facility, wherein a position of each respective smoke control element within the display of the schematic floor plan of the facility corresponds to a location in the facility of the component of the smoke control system represented by that smoke control element.

19. The computer readable medium of claim 18, wherein the instructions are executable by the processor to highlight the position of a smoke control element within the display of the schematic floor plan upon the component of the smoke control system represented by that smoke control element having a fault associated therewith.

20. The computer readable medium of claim 18, wherein the instructions are executable by the processor to, if multiple components of the smoke control system are at a particular location in the facility:
display, at the position within the display of the schematic floor plan that corresponds to the particular location in the facility, a quantity of the components of the smoke control system that are at the particular location in the facility; and
display, upon receiving a selection of the position within the display of the schematic floor plan that corresponds to the particular location in the facility, the smoke control elements that represent the components of the smoke control system that are at the particular location in the facility.
